(19) United States
(12) Patent Application Publication
(10) Pub. No.: US 2006/0287990 A1
(43) Pub. Date: Dec. 21, 2006

(54) Method of file accessing and database management in multimedia device

(75) Inventor: Jae Gu Yoon, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/455,105

(22) Filed: Jun. 19, 2006

(30) Foreign Application Priority Data
Jun. 20, 2005 (KR) 10-2005-0053235

(51) Int. Cl. G06F 17/30

(52) U.S. Cl. 707/3

(57) ABSTRACT

A multimedia file accessing method is provided. The method includes searching for file data in a file database, according to position data of a graphic user interface of a selected multimedia file, and accessing a physical file according to the file data.

### BACKGROUND OF THE INVENTION

1. Field of the Invention

The present invention relates to a method of file accessing and database management in a multimedia device, that provides functions for accessing music, photographs, moving images, and other multimedia files, managing file lists, checking file integrity, and backing up a file database.

2. Description of the Related Art

Memory card interfaces, hard disk drives, DVD recorders, and other multimedia devices with storage functions have recently been developed.

Digital televisions and other multimedia devices offer the functions of recording and playing back TV broadcasts, and playing back, deleting, copying, etc. of photographs, music, moving images, and other multimedia files.

A method for systematically managing a database (DB) in order to cope with the increasing amount and diversity of multimedia files being stored in multimedia devices is needed.

This applies especially to minimally using a multimedia device's resources while reducing the searching time for physical files, increasing the integrity of physical files, and providing an adequate backup for file DBs.

### SUMMARY OF THE INVENTION

Accordingly, the present invention is directed to a data accessing and database management method in a multimedia device that substantially obviates one or more problems due to limitations and disadvantages of the related art.

An object of the present invention is to provide a method for data accessing and database management in a multimedia device capable of quickly accessing multimedia files, efficiently managing file lists, reliably inspecting file DBs, and providing a backup function of files while minimally using the resources of the multimedia device.

Another object of the present invention is to provide a method for file searching and database management in a multimedia device capable of quickly accessing a requested file during playback, deleting, copying, etc. of a multimedia file.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a multimedia file accessing method including: searching for file data in a file DB (database) according to position data of a graphic user interface of a selected multimedia file; and accessing a physical file according to the file data.

In another aspect of the present invention, there is provided a multimedia device including: an input unit for inputting a user's commands; a control unit for controlling a displaying of multimedia files according to signals from the input unit and a managing of the multimedia files; a display for providing a list of the multimedia files through a graphic user interface according to the controlling of the control unit; a file DB (database) for storing file data of the multimedia files; a system memory for performing an accessing of physical files for the multimedia files; and a DB manager for searching for file data for multimedia files selected by the user in the file DB, and accessing physical files by using the system memory.

In a further aspect of the present invention, there is provided a database (DB) managing method for a multimedia device, including: comparing a check sum of a file DB to a check sum of a system memory; comparing the check sum of the system memory to a check sum of a backup file DB if a difference is found between the check sum of the file DB and the check sum of the system memory; and updating file data of the backup file DB to the file DB when the check sum of the system memory corresponds to the check sum of the backup file DB.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram showing the configuration of a database for managing multimedia files in a multimedia device according to the present invention;

FIG. 2 is a flowchart showing a file search method in a multimedia device according to the present invention;

FIG. 3 is a flowchart showing file data stored in a file database according to the present invention;

FIG. 4 is a flowchart showing a file DB checking method in a multimedia device according to the present invention;

FIG. 5 is a flowchart showing data file management relations during file processing according to the present invention;

FIG. 6 is a diagram showing the display of a multimedia file list through a graphical user interface in a multimedia device according to an embodiment of the present invention; and

FIG. 7 is a block diagram showing the configuration of a multimedia device according to an embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 5 is a flowchart showing data file management relations during file processing according to the present invention.

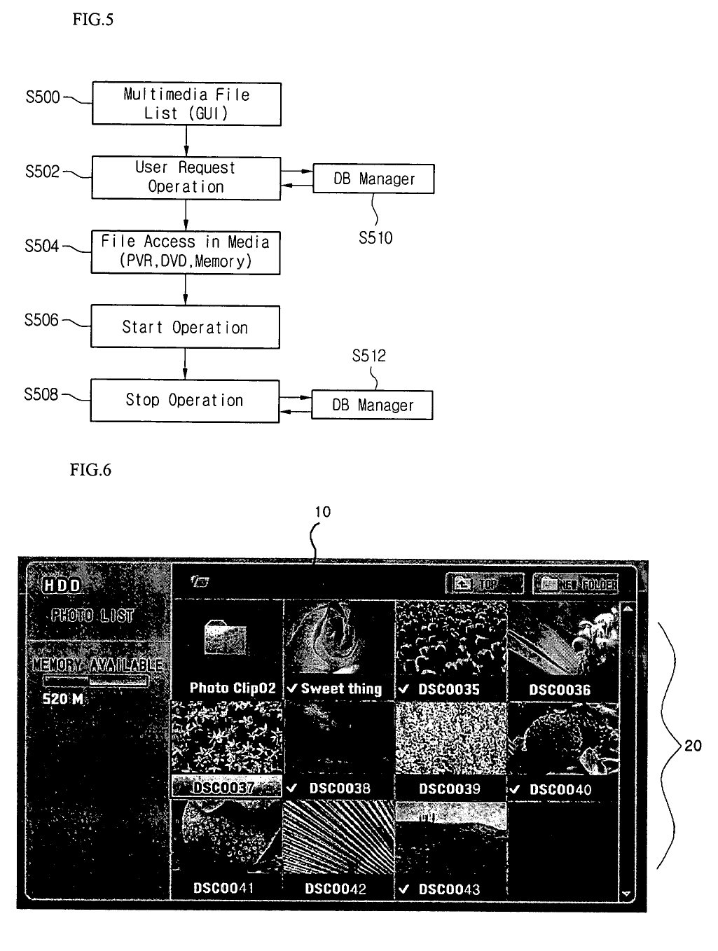

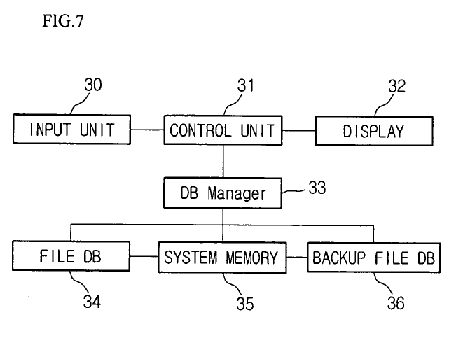

FIG. 6 is a diagram showing the display of a multimedia file list through a graphical user interface in a multimedia device according to an embodiment of the present invention, and FIG. 7 is a block diagram showing the configuration of a multimedia device according to an embodiment of the present invention.

The multimedia device according to the present invention may be a digital television. A digital television, unlike a computer, does not have an ample CPU and thus requires effective management of its database to access files using a minimal amount of resources.

Referring to FIGS. 5 through 7, the control unit 31 of the multimedia device displays a multimedia file list 20 through a graphical user interface (GUI) on a display 32 in step S500, whereupon a user can refer to the displayed file list 20 to select a desired operation (for example, playback, copying, deleting, etc. of a file) using an input unit 30 in step S502.

At this point, in order to perform an operation according to the user's input, the control unit 31 controls the managing operation of a DB manager 33 in step S510. Here, one of the managing operations of the DB manager may be to quickly search for the file to be played back, deleted, copied, etc.

When the searched file data is found through the DB manager 33, the found file data is accessed as a physical file from an initial recording medium, i.e., a personal video recorder (PVR), DVD, memory card, etc., in step S504. A desired operation (playback, deleting, copying, etc.) using this accessed file is begun in step S506.

Towards the end of the operation in step S508, the managing operation of the DB manager 33 becomes involved again in step S512. Here, the managing operation of the DB manager 33 includes backing up the file DB 34 and checking whether the physical files are incompatible with the file DB 34 during rebooting after ending or deleting files.

The structure of the file DB will now be described.

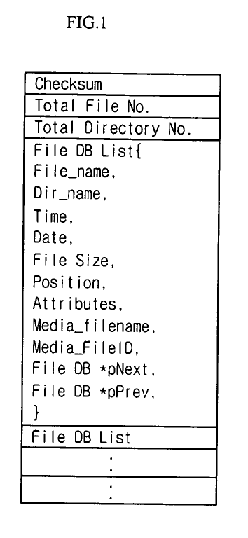

FIG. 1 is a diagram showing the configuration of a file DB 34 for managing multimedia files in a multimedia device according to the present invention.

Referring to FIGS. 1 through 6, to manage multimedia files, the file DB 34 stores check sum data, data on the total number of files, data on the total number of directories, and separate file data corresponding in number to the total number of files as a file DB list.

The file data stored in the file DB list according to an embodiment of the present invention includes file name (file_name), directory name (dir_name), time, date, file size, position, media file name (media_filename), media file ID (media_fileID), next file DB point (file DB *pnext), and previous file DB pointer (file DB *pprev).

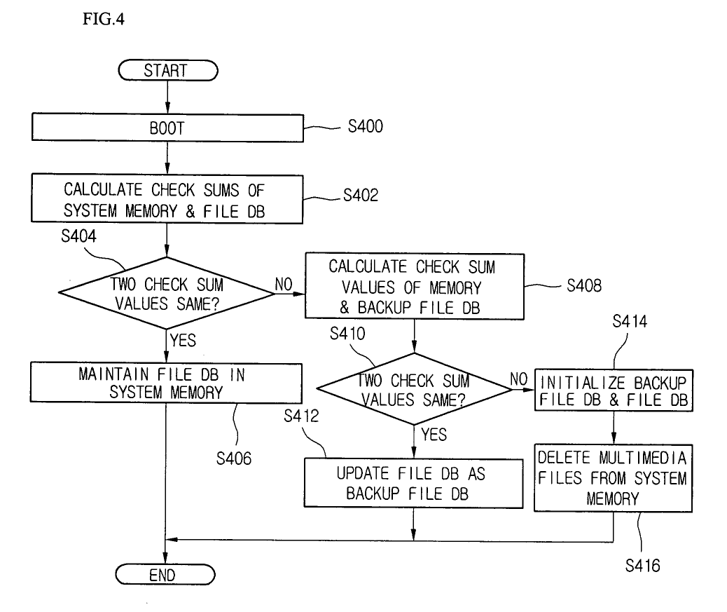

The dir_name and position in the file data, is stored in a linked state (as shown in FIG. 3), which will be described later.

The name of the directory stored in the file DB list is matched through the GUI with the filename path 10 displayed on the display 32. For example, the filename path 10, as a directory name storing multimedia files, is ‘Botanical Garden’, as shown in FIG. 6.

Accordingly, when a user selects a file to find in the GUI screen, the multimedia device selects a directory matching the selected filename path 10 in the file DB 34.

If the displayed multimedia file is stored in the ‘Photo Clip02’ directory, the filename path 10 would be ‘Botanical Garden/ Photo Clip02’.

The stored position in the file DB list may show data on the sequence of the multimedia file stored in the directory.

For example, in FIG. 6, ‘Sweet thing’ is the first multimedia file included in the ‘Botanical Garden’ directory, so its position data may be ‘1’. Also, ‘DSC0035’ is assigned ‘2’ as its position data, and ‘DSC0039’ is assigned ‘5’ as its position data.

Thus, the position data may be used to search for desired file data.

The media_filename and the media_fileID may have other media file systems according to the type of multimedia device, and corresponding physical existing file names and file IDs are used, which are linked to the searched file data, becoming data for finding physical files.

Thus, the method according to the present invention performs searches by using minimal data and resources until physical files are actually accessed, so that quick searches and efficient use of resources is possible.

The previous and next file DB pointers are for managing files and directory data as lists that are linked together. That is, directories and files stored in the file DB 34 are linked through the previous and next file DB pointers.

When the user inputs a command for playback, deleting, copying, etc. from the file list 20 displayed through the GUI using the above-described file DB 34, the pertinent file can quickly be searched.

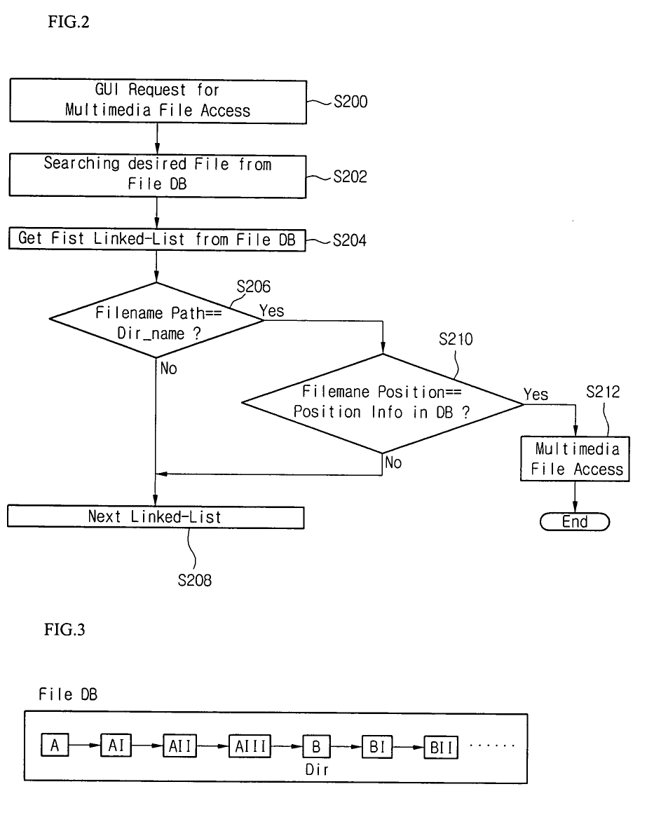

FIG. 2 is a flowchart showing a file DB management method for efficiently searching files in a multimedia device according to the present invention, and FIG. 3 is a flowchart showing file data stored in a file DB according to the present invention.

Referring to FIG. 2, when a user inputs a file search command through the input unit 30 of a multimedia device in step S200, the relevant directory is searched for in the file DB 34 in step S202. Specifically, when the user uses the file list 20 to select a desired file, the multimedia device searches for the filename path 10 and the matching directory in the GUI of the selected file in the file DB 34.

The files and directories stored in the file DB 34 are connected through links, so that the multimedia device can determine in step S206 whether the first directory stored in the file DB corresponds to the filename path 10.

If it is determined that the first directory does not correspond to the filename path 10, the multimedia device jumps to the second directory to determine if it corresponds to the filename path 10 in step S206. The multimedia device jumps to each directory in sequence until the directory corresponding to the filename path 10 is found.

After step S206 is performed, the multimedia device searches in step S210 for a file that has the position data corresponding to the filename position of the GUI of the file searched for in the found directory.

A detailed description of the file search method used by the multimedia device will now be given with reference to FIG. 3.

Referring to FIG. 3, each directory and file in the file DB 34 is linked in the following way: ‘directory A—file AI—file AII—file AIII—directory B—file BI—file BII . . . ’

To take an example, in a file DB 34 configured as above, when a user searches for file ‘BII’, the following process is performed.

When a search command is inputted in a multimedia device to find ‘BII’, the search begins from directory A to directory B in the file DB.

That is, because the directories and files in the file DB 34 are linked, the multimedia device determines whether the first directory in the file DB 34 corresponds with the filename path of the searched file. When it is determined that the filename path does not correspond to directory A, the multimedia device jumps to directory B that is linked to directory A. Because directory B corresponds with the filename path 10, the multimedia device searches directory B.

Then, the multimedia device searches for the file with the filename position of the GUI for the searched file from the files in directory B.

That is, the multimedia device determines whether the first file BI in directory B corresponds with the filename position. Because BI does not correspond with the filename position, the multimedia device moves to BII, which is linked to BI, and assesses whether BII corresponds with the filename position. When it is determined that BII corresponds to the filename position, the multimedia device searches for BII.

After step S210 is performed, the multimedia device uses the searched file data to access a physical file in step S206. Then, the file accessed is played back, deleted, copied, etc. by the user.

Thus, the method according to the present invention can employ the managing file DB and use minimal data and resources to perform a search until a physical file is accessed, thereby reducing the search time and use of resources.

FIG. 4 is a flowchart showing a file DB checking method in a multimedia device according to the present invention.

Referring to FIG. 4, when a multimedia device is booted in step S400, the multimedia device calculates the file check sum of files present in the system memory 35 and the check sum of the file DB 34 in step S402. The files present in the system memory 35 are physical files in the multimedia device.

After step S402 is performed, the multimedia device determines whether the calculated two check sum values correspond in step S404. If it is determined in step S404 that the two check sum values correspond, the multimedia device maintains the files in the system memory 35.

If it is determined in step S404 that the two check sum values do not correspond, the multimedia device calculates the file check sum present in the system memory 35 and the check sum value of the backup file DB 36 in step S408. Then, it is determined in step S410 whether the two check sum values correspond.

If it is determined in step S410 that the two check sum values correspond, the multimedia device updates the backup file DB 36 with the file DB 34 in step S412.

If it is determined in step S410 that the two check sum values do not correspond, the multimedia device initializes the files present in the system memory 35, the file DB 34, and the backup file DB 36 in step S414, and deletes the physical multimedia files present in step S416.

Also, the file DB update physically performs copying and deleting during the copying and deleting of the GUI, and thus updating of the file DB is performed, and the file DB is copied as a backup file DB 36 to make a backup.

During step S400, instead of the booting, when the physical files in the file DB and the system memory are incompatible due to file deletion, etc., steps S402 through S416 may be performed.

A file database management method for a multimedia device according to the present invention that uses a file DB configuration for simple file management (using the directory and file position in a GUI of the multimedia device) to provide list data to the GUI, and uses minimal data and resources while quickly searching files, is provided.

The present invention uses a file managing file DB configuration that uses a check sum, directory number, and file number of a multimedia device, in order to check whether physical files are compatible with managing DB files. When an incompatibility arises between physical files in the system memory and the managing DB files during booting, deleting, copying, etc., the detection of the incompatibility error prompts the performing of a file DB renewal or backup, so that the resources are efficiently managed and searches are conducted quickly, while the reliability of physical files and managing file DB is raised.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A multimedia file accessing method comprising:
searching for file data in a file DB (database) according to position data of a graphic user interface of a selected multimedia file; and
accessing a physical file according to the file data.

2. The multimedia file accessing method according to claim 1, wherein the position data includes a directory and a position.

3. The multimedia file accessing method according to claim 2, wherein the directory is a directory of multimedia files provided by the graphic user interface.

4. The multimedia file accessing method according to claim 2, wherein the position is a sequence of multimedia files provided by the graphic user interface.

5. The multimedia file accessing method according to claim 2, wherein the directory and the position are included in the file data stored in the file DB.

6. The multimedia file accessing method according to claim 1, wherein the file DB stores check sum data, a total number of files, a total number of directories, and file data for each file.

7. The multimedia file accessing method according to claim 1, wherein file data for each of the files stored in the file DB is linked.

8. The multimedia file accessing method according to claim 1, wherein the file data includes a media file name and a media file ID for a physical file.

9. A multimedia device comprising:
an input unit for inputting a user's commands;
a control unit for controlling a displaying of multimedia files according to signals from the input unit and a managing of the multimedia files;
a display for providing a list of the multimedia files through a graphic user interface according to the controlling of the control unit;
a file DB (database) for storing file data of the multimedia files;
a system memory for performing an accessing of physical files for the multimedia files; and
a DB manager for searching for file data for multimedia files selected by the user in the file DB, and accessing physical files by using the system memory.

10. The multimedia device according to claim 9, wherein the graphic user interface displays position data of a multimedia file, the position data being the same as position data stored in the file DB.

11. The multimedia device according to claim 10, wherein the position data includes a directory, in which the multimedia file is stored, and a position.

12. The multimedia device according to claim 9, wherein the file DB stores check sum data, a total number of files, a total number of directories, and file data for each file.

13. The multimedia device according to claim 9, wherein file data for each of the files stored in the file DB is linked.

14. The multimedia device according to claim 9, wherein the file data includes a media file name and a media file ID of a physical file.

15. The multimedia device according to claim 9, wherein the multimedia device is a digital television.

16. A DB (database) managing method for a multimedia device, comprising:
comparing a check sum of a file DB to a check sum of a system memory;
comparing the check sum of the system memory to a check sum of a backup file DB if a difference is found between the check sum of the file DB and the check sum of the system memory; and
updating file data of the backup file DB to the file DB when the check sum of the system memory corresponds to the check sum of the backup file DB.

17. The DB managing method according to claim 16, further comprising initializing file data of the file DB, file data of the system memory, and the file data of the backup file DB, if a difference is found between the check sum of the system memory and the check sum of the backup file DB.

18. The DB managing method according to claim 17, wherein the file data of the system memory is a physical file.

19. The DB managing method according to claim 16, wherein the file data of the system memory is maintained when the check sum of the file DB corresponds to the check sum of the system memory.
